(19) United States
(12) Patent Application Publication
(10) Pub. No.: US 2010/0225471 A1
(43) Pub. Date: Sep. 9, 2010

(54) Information providing server, server system, and method

(75) Inventors: Yasutaka Kawamoto, Hyogo (JP); Toshihisa Nakai, Osaka (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/656,489

(22) Filed: Feb. 1, 2010

(30) Foreign Application Priority Data
Mar. 4, 2009 (JP) 2009-050946

(51) Int. Cl. G08B 1/08

(52) U.S. Cl. 340/539.13

(57) ABSTRACT

An information providing server obtains user information from a user apparatus. The user information is dependent on a place at which the user was previously located. The information providing server decides, from the user information, whether the user has been present within a permission zone including an information acquisition apparatus, and interconnects the user apparatus and the information acquisition apparatus, directly or indirectly, only if such is the case. Users who were present within the permission zone are able to obtain information acquired by the information acquisition apparatus without going through a preliminary registration procedure, while other users are unable to obtain the acquired information.

### BACKGROUND OF THE INVENTION

1. Field of the Invention

The present invention relates to a method of providing information and a server and server system employing this method.

2. Description of the Related Art

Ubiquitous service is currently being studied as a paradigm for linking electronic devices, consumer electrical devices, and other such devices to operate in a coordinated manner. Specifically, it refers to technology for providing services that can be used by anyone, anywhere, without requiring the user to be aware of the devices involved. One example of a ubiquitous service is a monitoring service for a playground or park. Cameras are installed in the playground or park, and users can see the resulting images in their own homes, via the Internet. This service enables, for example, a parent with a personal computer at home to check on the safety of children playing in a park. If this service is available to anyone, however, it raises issues of privacy and security, which must be dealt with by restricting access to the service in some way.

In relation to such monitoring services, in Japanese Patent Application Publication (JP) No. 2005-134519, Muranaka discloses a map display device that enables the user to use the Global Positioning System (GPS) to identify an image server having a camera installed at a location the user wishes to monitor.

To use the disclosed device, however, the user has to register an identifier (ID) or an ID and a password in an authentication server in advance. A consequent problem is that even a user whose use of the monitoring service would raise no problems, and who therefore ought to be able to use the service, cannot do so until the registration process is completed.

A further problem is that when the numbers of users and cameras increase, since the server administrator has to manage a large number of IDs and passwords, the management task becomes complicated and costly.

### SUMMARY OF THE INVENTION

An object of the present invention is to provide information to a user apparatus in a way that protects privacy without requiring user registration.

An information providing server according to the invention has a user information acquisition unit, a user information assessment unit, and a connection control unit. The user information acquisition unit obtains, from a user apparatus, user information dependent on a place at which the user was previously located. The user information assessment unit decides whether the user was located within a permission zone including an information acquisition apparatus that obtains information for provision to the user apparatus. The connection control unit controls a connection between the information acquisition apparatus and the user apparatus so that they are connected, directly or indirectly, only if the user information assessment unit decides that the user was previously located within the permission zone.

The connection may also be made conditional on the time at which, or the length of time for which, the user was located within the permission zone.

The user information may include position information obtained from, for example, the Global Positioning System, other information that could only have been obtained within the permission zone, or information entered into the information acquisition apparatus and sent separately to the information providing server from the information acquisition apparatus and the user apparatus.

The user apparatus may include a first user device that obtains the user information or transmits the user information to the information acquisition apparatus, and a second user device that sends the user information to the information providing server and receives the information acquired by the information acquisition apparatus. The first and second user devices may communicate with each other to transfer the user information between them.

The above information providing server enables users to access information simply by demonstrating that they were previously present in the area in which the information was obtained. No registration or passwords are required, yet privacy is protected in that users cannot monitor or spy on places they have never visited in person.

The invention also provides a novel information providing server system including an information providing server, information acquisition apparatus, and user apparatus as described above.

The invention also provides a method of providing information including obtaining user information from a user apparatus and controlling a connection between the user apparatus and information acquisition apparatus disposed in a permission zone conditional on the user's previous presence in the permission zone, as described above.

### BRIEF DESCRIPTION OF THE DRAWINGS

In the attached drawings:

FIG. 1 schematically illustrates a conventional server system; and

FIG. 2 shows one example of a novel server system embodying the invention;

FIGS. 3A and 3B illustrate information provision operations in the novel server system;

FIG. 4 is a block diagram showing an exemplary functional configuration of the information providing server in FIG. 2;

FIG. 5 is a block diagram showing an exemplary functional configuration of the information acquisition apparatus in FIG. 2;

FIG. 6 is a block diagram showing an exemplary functional configuration of the user apparatus in FIG. 2;

FIG. 7 is a block diagram showing an exemplary hardware configuration of the information providing server in FIG. 2;

FIGS. 8, 9, and 10 are flowcharts illustrating three exemplary procedures for providing information in the novel server system; and

FIGS. 11, 12, and 13 are flowcharts illustrating three exemplary decision procedures in the novel server system.

### DETAILED DESCRIPTION OF THE INVENTION

Embodiments of the invention will now be described with reference to the attached drawings, in which like elements are indicated by like reference characters. For comparison, first a description will be given of a conventional server system for providing a monitoring service or similar image service.

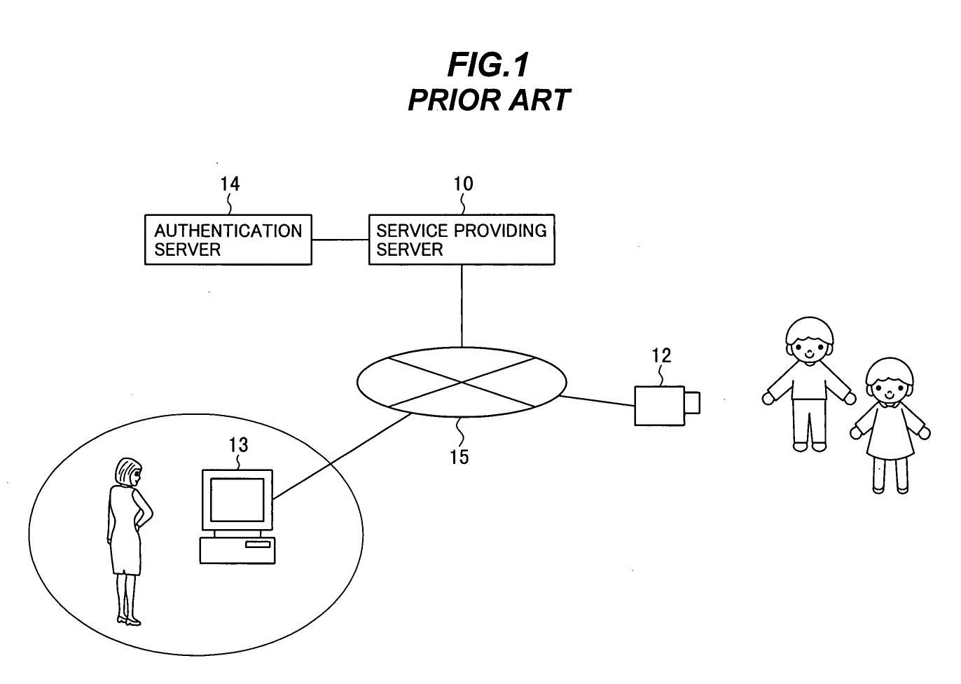

Referring to FIG. 1, the conventional server system includes a service providing server 10, a camera 12, and an authentication server 14. A user device 13 is connected to the service providing server 10 via a communication network 15. In order to obtain image information from the camera 12, the user accesses the service providing server 10 from the user device 13 via the network 15, sends his or her ID and password, and requests the image information from the service providing server 10. The service providing server 10 continuously receives image files from the camera 12. The service providing server 10 transfers the ID received from the user device 13 to the authentication server 14. The authentication server 14 decides whether the ID received from the user device 13 is legitimate, and sends its decision to the service providing server 10. If the ID is legitimate, the service providing server 10 starts supplying the image information received from the camera 12 to the user device 13. Accordingly, the user must deal with two servers: the service providing server 10 and, indirectly, the authentication server 14.

The server system disclosed in JP 2005-134519 operates like the conventional server system described above. Although JP 2005-134519 enables the user to receive image information, from an image server, monitored at a location identified by a GPS-capable map display device such as a car navigation system, access restriction conditions restricting access to the image server, and restricting the accessible images after access to the server is obtained, are set according to identification information such as an ID and password.

Another problem with many conventional ID and password based server systems is that if the user forgets his or her ID or password, the service becomes unavailable until the user has reregistered a new ID and/or password. This places users of low computer literacy at a disadvantage, and can create serious problems when the information to be provided is of an urgent nature. Another problem is that in conventional server systems, since authentication processing and the management of IDs are outsourced, as the numbers of users and cameras increase, the authentication cost also increases, as does the risk of leakage of users' personal information.

The novel server system described below solves all of these problems.

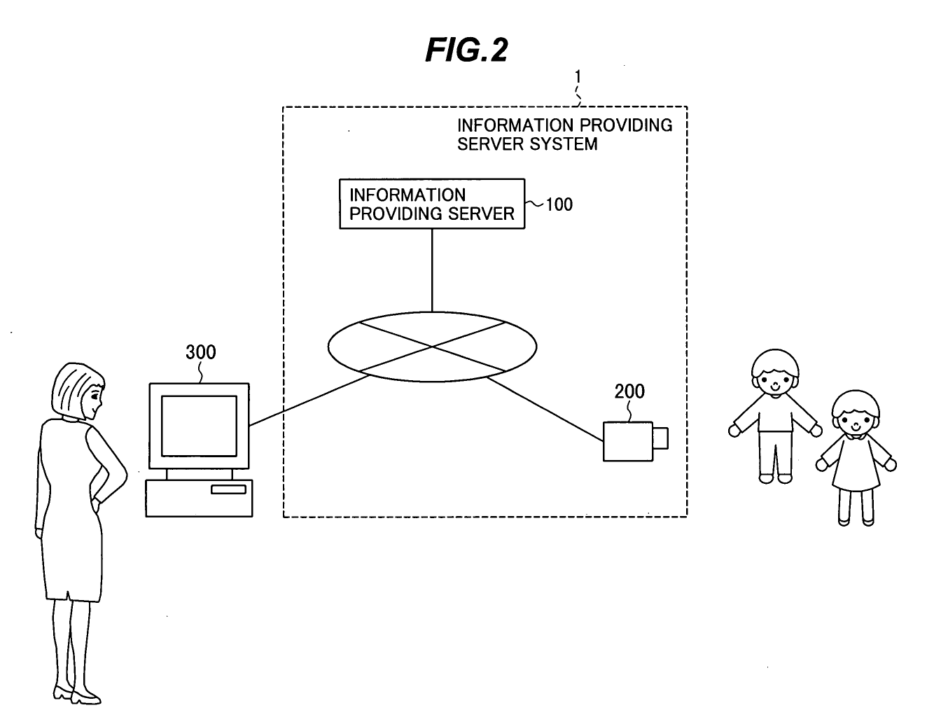

Referring to FIG. 2, the novel server system 1 includes an information providing server 100 and an information acquisition apparatus 200. The information acquisition apparatus 200 obtains information for provision to a user apparatus 300. The information providing server 100 connects the user apparatus 300 to the information acquisition apparatus 200 or gives permission for the connection so that the user apparatus 300 can obtain the information from the information acquisition apparatus 200. The user uses the user apparatus 300 to see or hear the information obtained by the information acquisition apparatus 200. The user apparatus 300 and the information providing server 100 communicate interactively across a communication network such as the Internet, and the information acquisition apparatus 200 and the information providing server 100 may also communicate interactively across this network. The user apparatus 300 cannot obtain information from the information acquisition apparatus 200 without mediation by or permission from the information providing server 100.

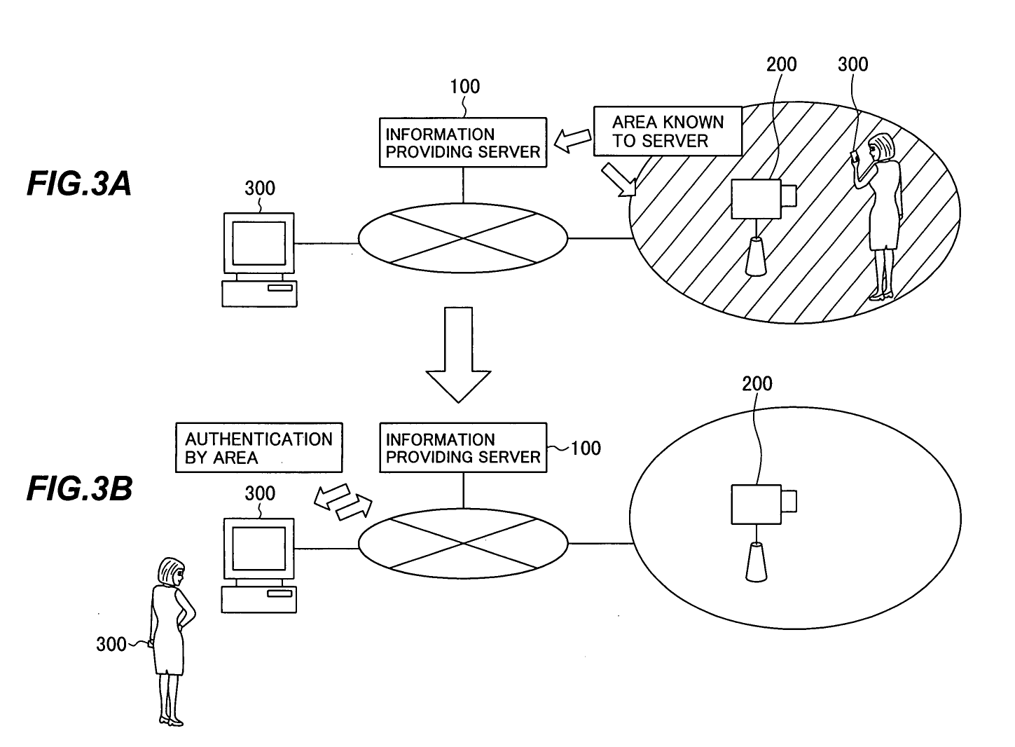

The novel server system will now be briefly described with reference to the exemplary information provision operations illustrated in FIGS. 3A and 3B. The user apparatus 300 in this example includes two user devices: a personal computer, also shown in FIG. 2, and a mobile device such as a portable telephone which the user carries into a permission zone (hatched) around the information acquisition apparatus 200.

In FIG. 3A the user's mobile device obtains position information indicating that the mobile device is in the permission zone, and stores this position information as user information. The information providing server 100 already stores position information defining the permission zone including the information acquisition apparatus 200.

In FIG. 3B, the user transfers the user (position) information obtained by the mobile device to the personal computer, and uses the personal computer to send user information including this position information to the information providing server 100 together with a request for information from the information acquisition apparatus 200. The information providing server 100 compares the position of the information acquisition apparatus 200 with the position information received from the user's personal computer. If the information providing server 100 finds that the received position information was obtained in the permission zone around the information acquisition apparatus 200, the information providing server 100 decides that the user has a legitimate right to obtain the requested information, and sends the information from the information acquisition apparatus 200 to the user's personal computer 300, where the information is seen or heard by the user.

Although the personal computer and mobile device are separate devices, to the system the are both simply regarded as parts of the user apparatus 300.

Since the information providing server 100 permits only users who had been present in the permission zone around the information acquisition apparatus 200 to access information from the information acquisition apparatus 200, privacy and security are protected to the extent that users cannot randomly spy or eavesdrop on places they had never visited. Since authentication by a separate authentication server is not required, however, users who had visited a particular place can view scenes or listen to sounds of the same place later without having to register an ID and/or password in advance.

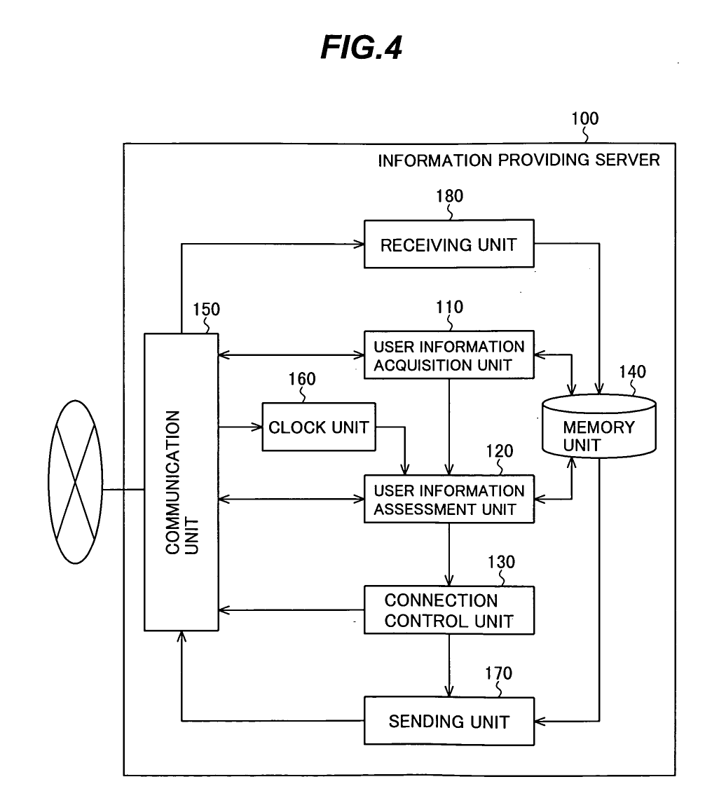

Referring to the block diagram in FIG. 4, the information providing server 100 of the novel server system 1 includes a user information acquisition unit 110, a user information assessment unit 120, a connection control unit 130, a memory unit 140, a communication unit 150, a clock unit 160, a sending unit 170, and a receiving unit 180.

The user information acquisition unit 110 obtains user information from the user apparatus 300, and may also obtain user information from the information acquisition apparatus 200. In either case the user information is obtained via the communication unit 150, and is dependent on a place at which the user was previously located. For example, user information obtained from the information acquisition apparatus 200 may be arbitrary information entered directly into the information acquisition apparatus 200, thereby establishing that the person who entered the information was present at the information acquisition apparatus 200. The user information acquisition unit 110 may store the user information in the memory unit 140, read the user information from the memory unit 140, and supply the user information to the user information assessment unit 120. The user information acquisition unit 110 may also use the user information to calculate a time period during which the user was located in the permission zone.

The user information may include position information such as absolute geographical coordinates or relative distances from one or more predetermined positions, or information that could only have been obtained at a particular place, such as information displayed only at that place. Such user information can be used as a user authentication key.

If differing user information is generated at different times, the user information acquisition unit 110 in the information providing server 100 may also determine a point in time or a period of time when the user was located in a particular area.

From the information supplied by the user information acquisition unit 110, the user information assessment unit 120 decides whether the user was located within a permission zone. The user information assessment unit 120 may also decide whether the user's presence in the permission zone occurred more than a predetermined length of time ago. In addition, the user information assessment unit 120 may calculate the length of the time period during which the user was located within the permission zone, and decide whether this length of time is equal to or greater than a predetermined length. The user information assessment unit 120 may supply these decisions to the connection control unit 130 or store them in the memory unit 140.

The above predetermined length and predetermined length of time may be set by the administrator of the information providing server 100 to values suitable for the mode of operation of the information providing server 100.

The connection control unit 130 controls the direct or indirect connection between the information acquisition apparatus 200 and the user apparatus 300 according to the decision information received from the user information assessment unit 120. The connection control unit 130 may control the connection so that the information acquisition apparatus 200 and the user apparatus 300 are connected directly via the Internet, or so that the information acquisition apparatus 200 and the user apparatus 300 are connected indirectly via the information providing server 100, a proxy server, or a mail server.

The memory unit 140 stores the user information. The memory unit 140 may also store a history of information obtained by the user information acquisition unit 110 and decisions made by the user information assessment unit 120.

The communication unit 150 communicates with the information acquisition apparatus 200, the user apparatus 300, and other devices via the Internet or one or more other networks. The communication unit 150 can transfer information received from the information acquisition apparatus 200 to the user apparatus 300.

The clock unit 160 counts time and supplies present time information on request to, for example, the user information assessment unit 120 and connection control unit 130.

Under control of the connection control unit 130, the sending unit 170 sends information received from the information acquisition apparatus 200 and information stored in the memory unit 140 to other devices via the communication unit 150, using a predetermined protocol. Exemplary protocols that may be used include the Hypertext Transfer Protocol (HTTP) and Simple Mail Transport Protocol (SMTP). The information sent may include user information, information provided from the information acquisition apparatus 200 to the user apparatus 300, and other information.

The receiving unit 180 receives, via the communication unit 150, information from the information acquisition apparatus 200 for provision to the user apparatus 300, and stores the information in the memory unit 140.

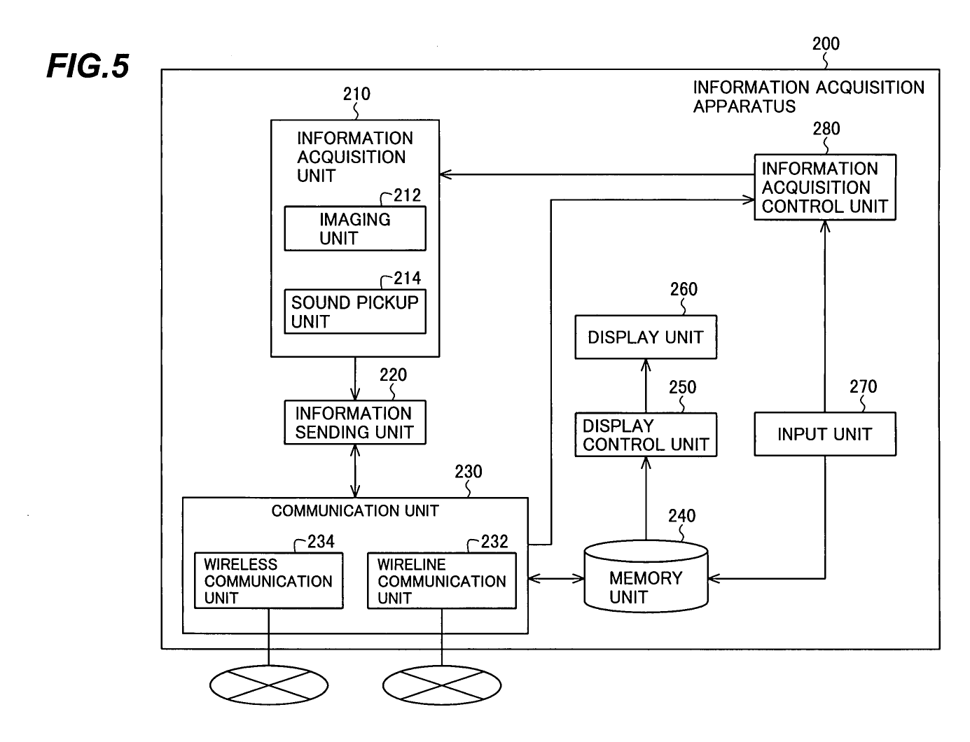

Referring to the block diagram in FIG. 5, the information acquisition apparatus 200 of the novel server system 1 includes an information acquisition unit 210, an information sending unit 220, a communication unit 230, a memory unit 240, a display control unit 250, a display unit 260, an input unit 270, and an information acquisition control unit 280.

The information acquisition unit 210 obtains information for provision to the user apparatus 300. The information acquisition unit 210 includes an imaging unit 212 for capturing images to obtain image data, and a sound pickup unit 214 for capturing sound via a microphone or one or more other devices to obtain sound data. The information obtained by the information acquisition unit 210 is therefore audio-visual information representing a still or moving image with sound. The information acquisition unit 210 may obtain such information continuously or at evenly spaced intervals. The information acquisition unit 210 may supply the acquired information directly to the information sending unit 220, or store the acquired information in the memory unit 240.

On request, the information sending unit 220 sends the acquired information to the user apparatus 300 or the information providing server 100 via the communication unit 230.

The communication unit 230 includes a wireline communication unit 232 for wireline communication and a wireless communication unit 234 for wireless communication. The wireless communication unit 234 may be implemented as, for example, an active tag or part of an active tag system. The communication unit 230 communicates with the information providing server 100, the user apparatus 300, and other devices.

The memory unit 240 stores the audio-visual information obtained by the information acquisition unit 210 and operating information related to various commands or user information entered into the input unit 270 or operations performed on the input unit 270 by the user. Storage may be temporary, old information being discarded as new information is obtained, or cumulative, old information being retained and new information being added thereto. The information sending unit 220 can read the information stored in the memory unit 240 and send the information to the user apparatus 300 or the information providing server 100 via the communication unit 230.

The display control unit 250 reads audio-visual information, user information, or other information stored in the memory unit 240, and directs the display unit 260 to display the information.

Under control of the display control unit 250, the display unit 260 displays various information.

When the user enters information or commands into or performs operations on the input unit 270, the input unit 270 sends corresponding electrical signals to the memory unit 240.

The information acquisition control unit 280 controls the information acquisition operations of the information acquisition unit 210 according to user input on the input unit 270 or commands received through the communication unit 230, or to commands or information received from the user apparatus 300 via the communication unit 230.

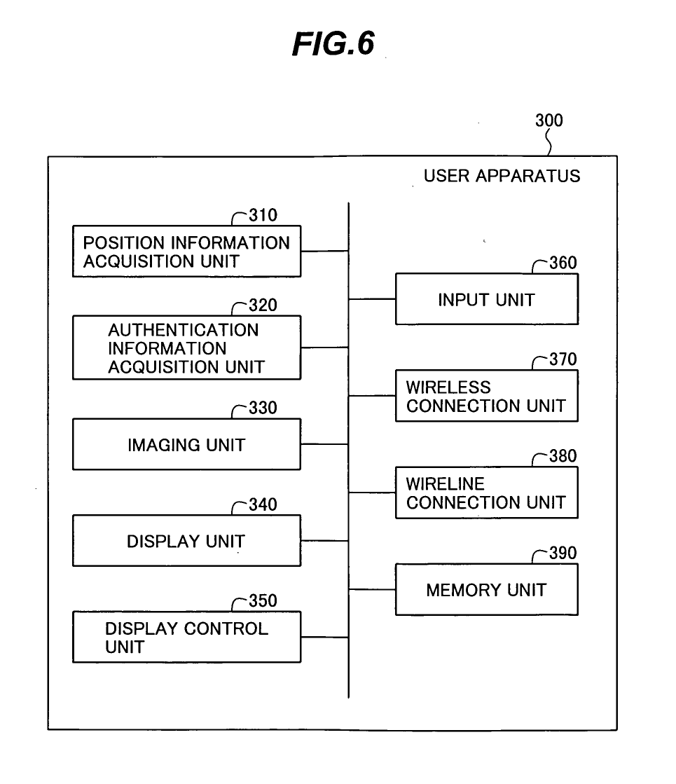

Referring to the block diagram in FIG. 6, the user apparatus 300 in the novel server system 1 includes a position information acquisition unit 310, an authentication information acquisition unit 320, an imaging unit 330, a display unit 340, a display control unit 350, an input unit 360, a wireless connection unit 370, a wireline connection unit 380, and a memory unit 390.

The position information acquisition unit 310 obtains position information that indicates a place at which the user apparatus 300 is present. The position information may indicate a relative position, or an absolute position such as a GPS position.

The authentication information acquisition unit 320 obtains authentication information. The authentication information is received from the information acquisition apparatus 200 or another device via the wireless connection unit 370 or wireline connection unit 380.

The imaging unit 330 captures images to obtain image data. The imaging unit 330 may store the image data in the memory unit 390.

The display unit 340 displays various information under control of the display control unit 350.

The display control unit 350 directs the display unit 340 to display audio-visual information or other information stored in the memory unit 390, or obtained from the information providing server 100 or the information acquisition apparatus 200 via the wireless connection unit 370 or wireline connection unit 380.

When the user enters information or commands into or performs operations on the input unit 360, the input unit 360 sends corresponding electrical signals to the memory unit 390.

The wireless connection unit 370 connects with the information acquisition apparatus 200 or other devices via wireless communication channels. The wireline connection unit 380 connects to the information acquisition apparatus 200 or other devices via wireline communication channels. The wireless connection unit 370 and wireline connection unit 380 may obtain user information by communicating with the information acquisition apparatus 200. One user device and another user device in the user apparatus 300 may exchange user information by wireless communication.

The memory unit 390 temporarily or cumulatively stores the user information obtained from the information acquisition apparatus 200, and the audio-visual information representing a still or moving image with sound obtained from the information providing server 100 or the information acquisition apparatus 200.

As noted above, the user apparatus 300 may include two or more distinct user devices, one being used to obtain user information and another being used to receive and display audio-visual information. The user in the following description has two user devices: a mobile device such as a portable telephone that the user carries from place to place, and a personal computer installed in the user's home. Some of the blocks in FIG. 6 are present in both the mobile device and the personal computer, while other blocks are present in only the mobile device, or only the personal computer. The user may use the mobile device to obtain position information from the information acquisition apparatus 200, store this position information as user information in the mobile device, and transfer the user information from the mobile device to the personal computer. The user may then use the personal computer to send user information including the position information to the information providing server 100 together with a request for information from the information acquisition apparatus 200, and receive the requested information.

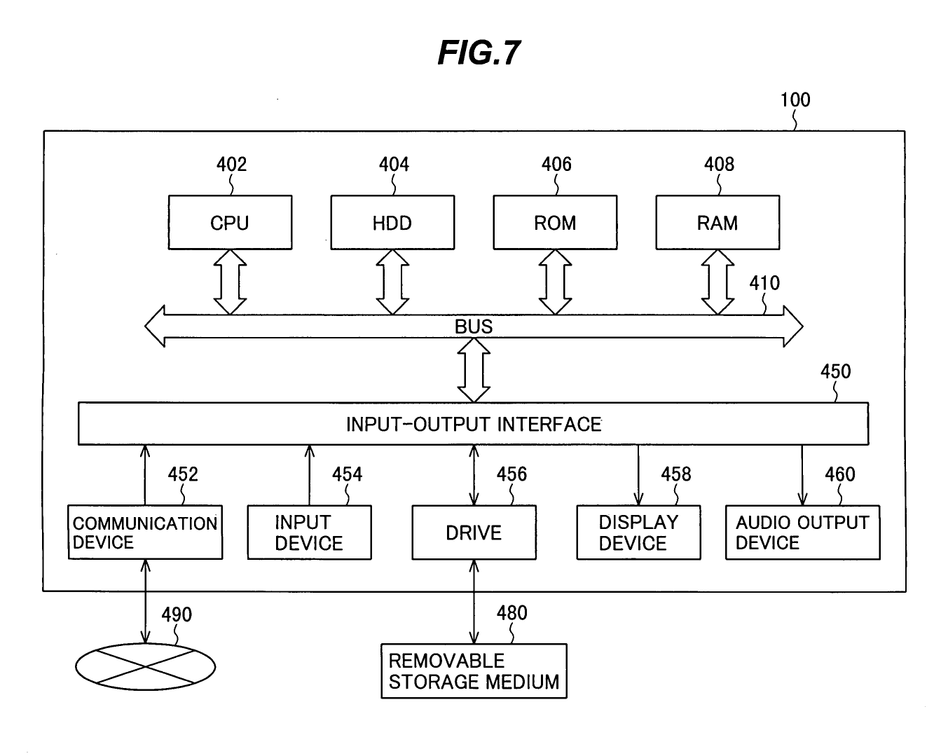

The hardware elements of the information providing server 100 will now be described with reference to the exemplary computer illustrated in FIG. 7.

This computer (the information providing server 100) includes a central processing unit (CPU) 402, a hard disk drive (HDD) 404, read-only memory (ROM) 406, random-access memory (RAM) 408, a communication device 452, an input device 454, a drive 456, a display device 458, an audio output device 460, and a bus 410 and an input-output interface 450 for interconnecting these elements to convey information between them.

Program code may be stored in the hard disk drive 404, ROM 406, or RAM 408.

Programs may also be temporarily or permanently recorded in a removable storage medium 480 such as a removable semiconductor memory or a removable rotating disk memory. Examples of removable rotating disk memory include flexible magnetic disks and various types of compact discs (CDs), magneto-optical (MO) discs, and digital versatile discs (DVDs). The removable storage medium 480 may store so-called packaged software, which may be read by the drive 456 and stored in the hard disk drive 404 or RAM 408 via the input-output interface 450 and bus 410.

Programs may also be stored in another computer or memory device (not shown) or at a download site and transferred to the information providing server 100 through a network 490 such as a local-area network (LAN) or the Internet. Such programs are received by the communication device 452 and may be stored in the hard disk drive 404 or RAM 408 via the input-output interface 450 and the bus 410.

The information provision operations of the information providing server 100 that were described above are carried out when the CPU 402 executes programs stored in the ROM 406, the RAM 408, or a removable storage medium 480, or received via the network 490. Such programs may first be loaded into the RAM 408 and executed from the RAM 408, or the CPU 402 may execute a program read directly from the hard disk drive 404 or ROM 406. A program received by the communication device 452 or the drive 456 from the network 490 or removable storage medium 480 may be executed without being stored in the hard disk drive 404.

In executing these programs, the CPU 402 may also process electrical signals or information entered through the input device 454 by such means as a mouse, keyboard, or microphone (not shown).

The CPU 402 may send results obtained by executing these programs to the information acquisition apparatus 200 and the user apparatus 300 via the communication device 452, and may save the results in the hard disk drive 404 or a removable storage medium 480.

Detailed descriptions of the hardware configurations of the information acquisition apparatus 200 and user apparatus 300 will be omitted because they are similar to the configuration shown in FIG. 7.

The operation of the novel server system 1 will now be described through three examples, which differ in the type of user information used and its method of acquisition.

### EXAMPLE ONE

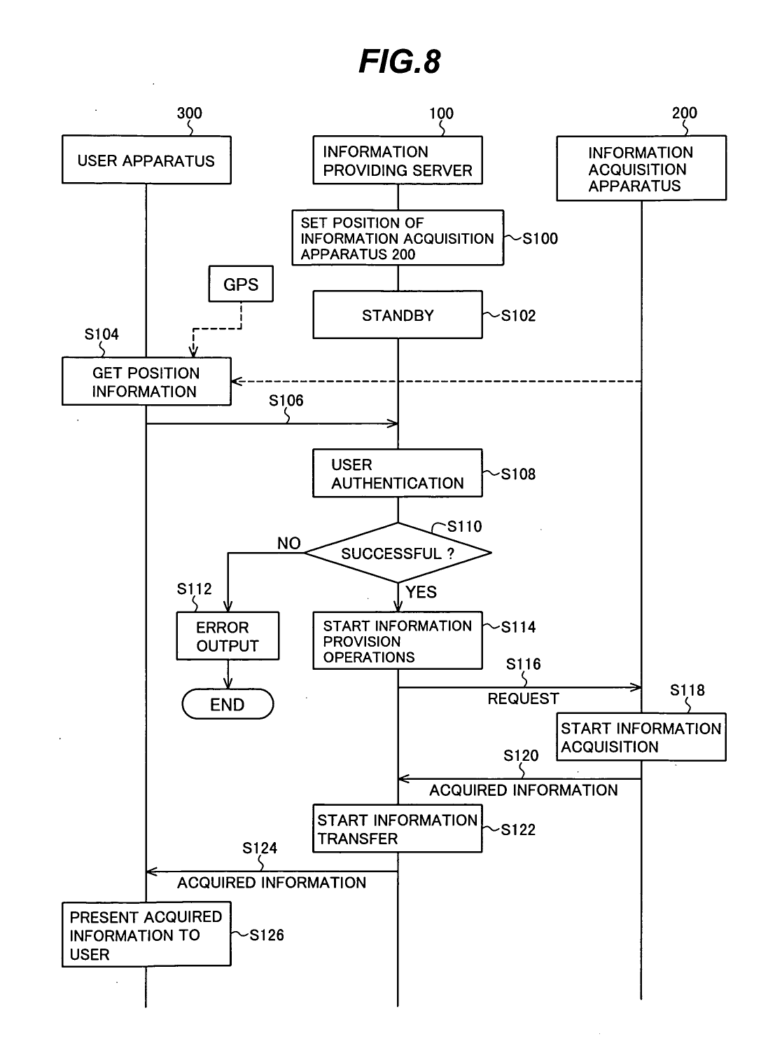

The information provision operations by the novel server system in example one up to the point at which the user apparatus 300 begins receiving information will now be described with reference to the flowchart in FIG. 8. In this example, the user has a single user apparatus 300, which is a mobile device.

First, the server administrator or the information acquisition apparatus 200 provides the position of the information acquisition apparatus 200 to the information providing server 100, where it is stored in the memory unit 140 (step S100). The information providing server 100 then enters a standby state and waits to receive a request from the user apparatus 300 (step S102).

The user carries the user apparatus 300 into a permission zone around the information acquisition apparatus 200, where the user apparatus 300 obtains position information indicating that the user apparatus 300 is in the permission zone (step S104). Later, the user apparatus 300 sends user information including this position information to the information providing server 100 together with a request for information from the information providing server 100 (step S106). The user information assessment unit 120 in the information providing server 100 receives the user information and begins user authentication (step S108).

The user information assessment unit 120 extracts the position information from the user information received from the user apparatus 300, and decides whether the user was located within the permission zone around the information acquisition apparatus 200 when the position information was obtained (step S110). If the position information defines a location outside the permission zone, authentication fails and the user information assessment unit 120 generates an error message (step S112). If the position information defines a location inside the permission zone, authentication succeeds and the user information assessment unit 120 allows the information providing server 100 to start information provision operations (step S114). The information providing server 100 then requests information from the information acquisition apparatus 200 (step S116).

On receiving the request, the information acquisition apparatus 200 starts acquiring information (step S118), and sends the acquired information (images etc.) to the information providing server 100 (step S120). The information providing server 100 receives the information from the information acquisition apparatus 200, stores the information in its memory unit 140, then initiates transfer of the information (step S122) to send the information to the user apparatus 300 (step S124). The user apparatus 300 receives the information, and the user can use the user apparatus 300 to see or hear the information (step S126).

The scheme for sending information to the user apparatus 300 in example one is not restricted to the above scheme in which the information providing server 100 receives the information from the information acquisition apparatus 200 and transfers the information to the user apparatus 300. The information acquisition apparatus 200 may send the information directly to the user apparatus 300.

Although the user has only one user apparatus 300 in example one, as already explained, the apparatus may include more than one user device. For example, the user may use a mobile device to obtain position information and then use a stationary device such as a personal computer to receive audio-visual information from the information providing server 100, after entering the user information obtained by the mobile device into the input unit 360 of the personal computer by hand, or transferring the user information to the input unit 360 by wireless communication (automatically, for example, as part of an active tag system).

### EXAMPLE TWO

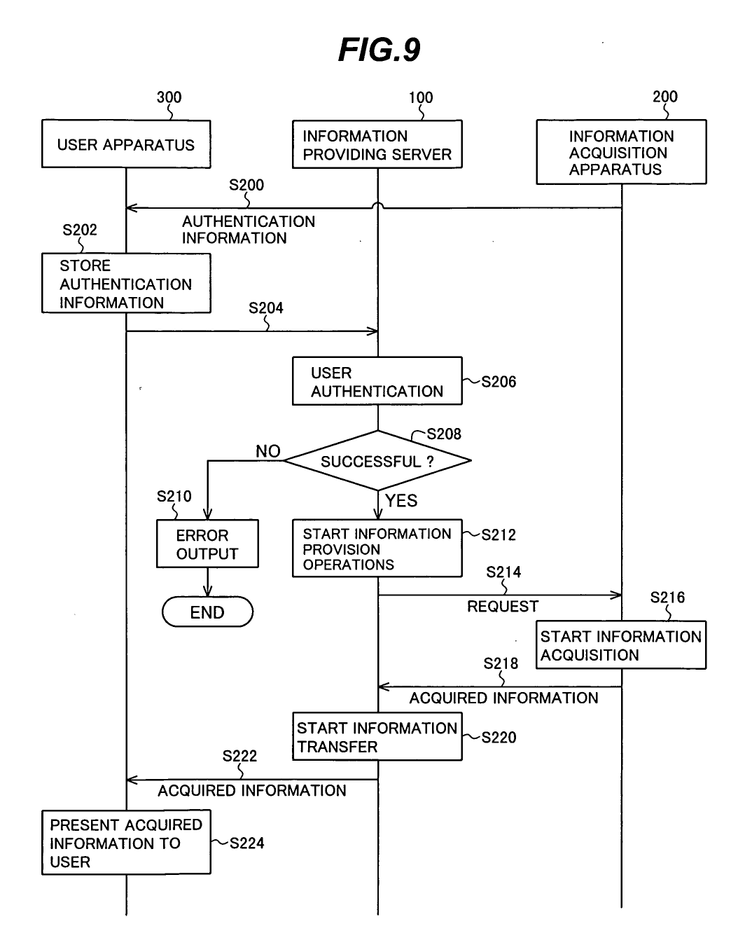

The information provision operations carried out in the novel server system in example two will now be described with reference to the flowchart in FIG. 9. In this example also, the user apparatus 300 is a mobile device.

When power is turned on, the information acquisition apparatus 200 transmits authentication information via wireless broadcasting continuously or at evenly spaced intervals, at a power level such that the transmission reaches only the permission zone around the information acquisition apparatus 200 (step S200). The user brings the user apparatus 300 into the permission zone, and the user apparatus 300 receives the broadcast from the information acquisition apparatus 200 and stores the authentication information in the memory unit 390 (step S202). Later, the user apparatus 300 sends the authentication information obtained from the information acquisition apparatus 200 as user information to the information providing server 100 together with a request for information from the information providing server 100 (step S204). When the information providing server 100 receives the user information, the user information assessment unit 120 performs user authentication (step S206).

Steps S208 to S224 proceed in the same way as steps S110 to S126 in FIG. 8 in example one. A repeated description will be omitted.

### EXAMPLE THREE

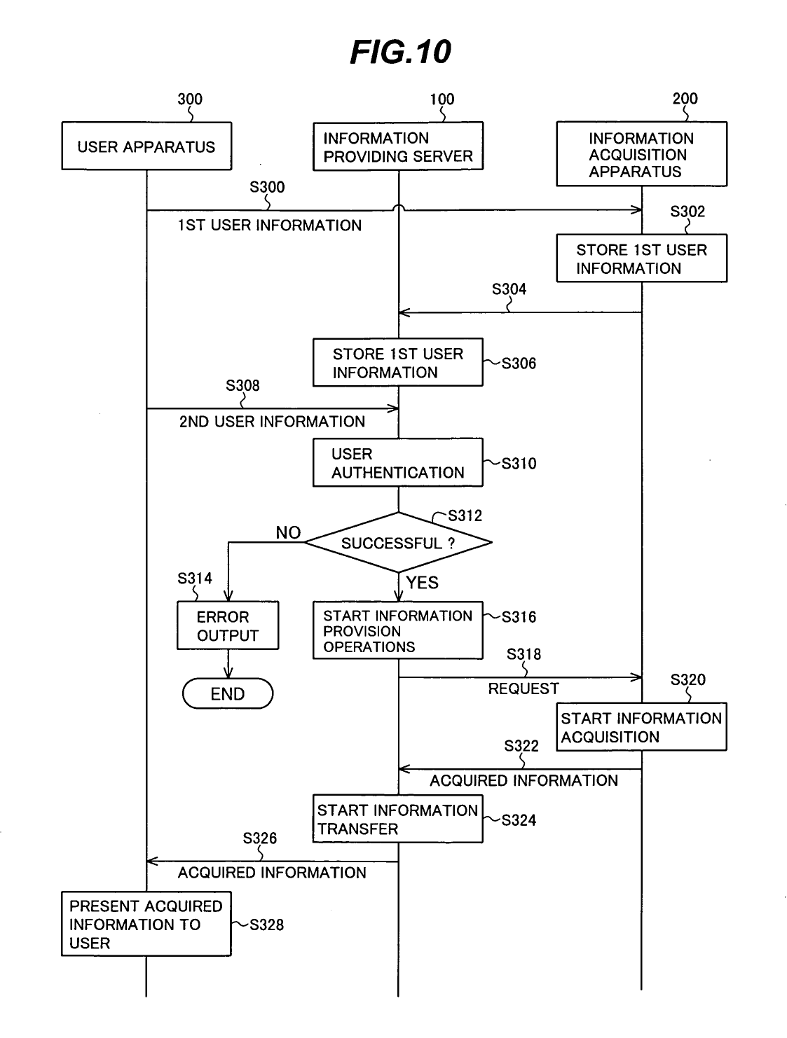

The information provision operations by the novel server system in example three will now be described with reference to the flowchart in FIG. 10.

To begin the procedure, the wireless connection unit 370 of the user apparatus 300 sends first user information to the information acquisition apparatus 200 via wireless communication (step S300). The information acquisition apparatus 200 stores the first user information in the memory unit 240 (step S302) and sends the first user information to the information providing server 100 (step S304), and the information providing server 100 stores the first user information in the memory unit 140 (step S306). Alternatively, the information acquisition apparatus 200 may send the first user information to the information providing server 100 in response to a query from the information providing server 100. Later, the user apparatus 300 sends the information providing server 100 second user information identical to first user information, with a request for information from the information providing server 100 (step S308). The user information assessment unit 120 of the information providing server 100 performs user authentication by comparing the second user information received from the user apparatus 300 with the first user information stored in the memory unit 140 (step S310). If the second user information is identical to the first user information, then the user is presumed to have been in the permission zone around the information acquisition apparatus 200, authentication succeeds, and the user information assessment unit 120 allows the information providing server 100 to start information provision operations (steps S316 to S328). If the second user information differs from the first user information, authentication fails and the user information assessment unit 120 generates an error message (step S314).

Steps S316 to S328 proceed in the same way as steps S114 to S126 in FIG. 8 in example one. A repeated description will be omitted.

The method of sending the first user information to the information acquisition apparatus 200 in example three is not restricted to wireless communication. The user apparatus 300 may send the first user information by wireline communication. The user may also transfer the first user information from the user apparatus 300 to the information acquisition apparatus 200 by entering information or commands into or performing other operations on the input unit 270 of the information acquisition apparatus 200 in step S300, or may enter identical first user information in both the information acquisition apparatus 200 and the user apparatus 300.

The information providing server 100 is not restricted to the modes of operation described in examples one to three. The information providing server 100 may obtain similar or other user information by using other or similar methods. It is only necessary for the user information to depend on a place at which the user was previously located, so that whether the user was located within the permission zone around the information acquisition apparatus 200 can be determined from the information. For example, any of the following information A to F may be used as user information.

(A) Absolute position information (for example, GPS position information)

(B) Relative position information (for example, information indicating the distance from the information acquisition apparatus 200 to the user apparatus 300)

(C) Unique information about the information acquisition apparatus 200 that could only have been obtained around the information acquisition apparatus 200 (for example, a unique ID, or a unique ID and a unique password, transmitted from the information acquisition apparatus 200 by short-range wireless broadcasting)

(D) Image information that could only have been obtained around the information acquisition apparatus 200 (for example, a still or moving picture of the information acquisition apparatus 200 or its surrounding area)

(E) Information indicated on the information acquisition apparatus 200 (for example, a two-dimensional bar code or serial number appearing on the exterior of the information acquisition apparatus 200, or information displayed on its display unit 260)

(F) A combination of two or more types of information A to E

When a unique ID transmitted by short-range wireless broadcasting or information displayed on the display unit 260 is used as user information, the user information may vary over time. For example, the information acquisition apparatus 200 may change its unique ID periodically. If the information providing server 100 has prestored information describing these changes, on receiving the unique ID from the user apparatus 300, the information providing server 100 can find out when the user brought the user apparatus 300 into the permission zone by checking the prestored information. Accordingly, the information providing server 100 can authenticate the user information with regard to time as well as location, thereby improving the security of the novel server system.

Exemplary methods that the user information assessment unit 120 may use to decide, from the user information, whether the user was located within the permission zone around the information acquisition apparatus 200 will now be described as decision methods one to four. The information providing server 100 may be capable of selecting different decision methods for different types of user information and different modes of operation. Although position information is used as user information in decision methods one to four for convenience of description, the user information is not restricted to position information.

### Decision Method One

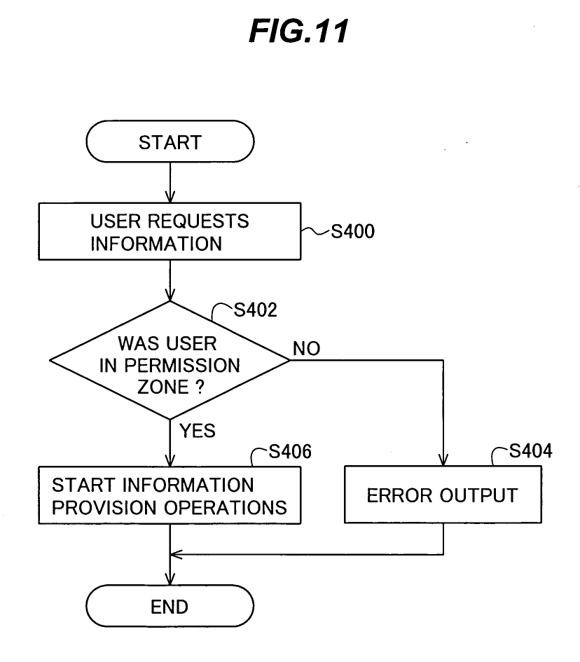

Decision method one, in which the user information assessment unit 120 decides whether the user has been within the permission zone around the information acquisition apparatus 200, will now be described with reference to the flowchart in FIG. 11.

To begin the procedure, the user apparatus 300 sends user information including position information to the information providing server 100 together with a request for information from the information providing server 100 (step S400). When the information providing server 100 receives the request, the user information acquisition unit 110 obtains the position information from the user information and supplies the position information to the user information assessment unit 120. The user information assessment unit 120 decides, from the position information, whether the user was located within the permission zone around the information acquisition apparatus 200 (step S402) and sends the result of its decision to the connection control unit 130. If the decision is that the user was outside the permission zone, an error message is sent to the user apparatus 300 (step S404). If the decision is that the user was inside the permission zone, then the necessary connections are made and the information acquisition apparatus 200 starts sending information to the user apparatus 300 (step S406), so that the information can be viewed or listened to by the user. The decision operation by the user information assessment unit 120 ends after step S404 or step S406.

Decision method one enables the information providing server 100 to control access to information on the basis of position, without having to maintain a database of user IDs and passwords.

The mode of operation of the information providing server 100 according to decision method one will now be described through an exemplary case in which the information acquisition apparatus 200 is a surveillance camera installed on the premises of a nursery school, the user is a parent of a nursery school child, and the user apparatus 300 includes two user devices: a portable telephone and a personal computer.

On his or her way to work the parent takes the child to the nursery school, and the portable telephone, which the parent is carrying, automatically obtains position information on the premises of the nursery school. Later, the parent sends the position information as user information to the information providing server 100 from a personal computer in the parent's home or office, together with a request for image information obtained by the camera at the nursery school. The information providing server 100 confirms, from the position information, that the user has been on the premises of the nursery school, and the image information is sent from the nursery school to the personal computer and can be viewed by the parent.

If a third party who does not have access to the nursery school premises tries to obtain the same image information, user authentication of the third party by the information providing server 100 fails because the third party was not able to obtain the necessary position information, so the third party cannot view the nursery school images obtained by the camera. The privacy of the parent, child, and nursery school is thereby protected, even though the parent has easy access to the nursery school images without having to register an ID or remember a password.

### Decision Method Two

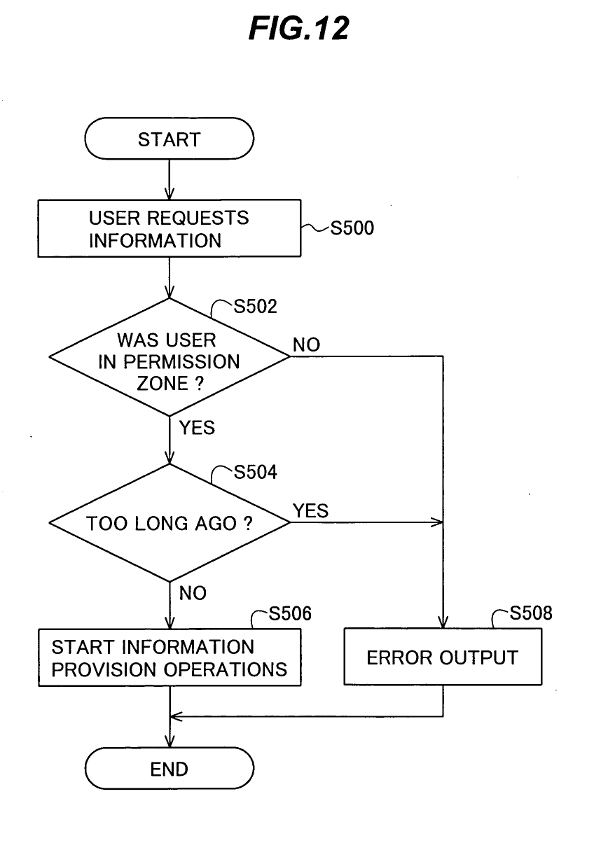

Decision method two, in which the user information assessment unit 120 decides whether the user was located within the permission zone around the information acquisition apparatus 200 and also decides when the user was present in the permission zone, will now be described with reference to the flowchart in FIG. 12.

To begin the procedure, the user apparatus 300 sends user information including position information to the information providing server 100 together with a request for information from the information providing server 100 (step S500). When the information providing server 100 receives the request, the user information acquisition unit 110 obtains the position information from the user information and supplies the position information to the user information assessment unit 120. The user information assessment unit 120 decides, from the position information, whether the user was located within the permission zone around the information acquisition apparatus 200 (step S502). If the decision is that the user was outside the permission zone, an error message is sent to the user apparatus 300 (step S508). If the decision is that the user was inside the permission zone, the decision operation proceeds to step S504.

In step S504, the user information assessment unit 120 decides whether the user's presence in the permission zone occurred within a period of time of a predetermined length extending back from a present time, and sends the result of its decision to the connection control unit 130. If the decision is that the user was present in the permission zone not more than the predetermined length of time ago, the necessary connections are made and the information acquisition apparatus 200 starts sending information to the user apparatus 300 (step S506). If the decision is that the user's presence in the permission zone occurred more than the predetermined length of time ago, an error message is sent to the user apparatus 300 (step S508).

In step S504, instead of deciding whether the user's presence in the permission zone occurred more than a predetermined length of time ago, the user information assessment unit 120 may compare the time at which the user obtained the position information in the permission zone with a specific time stored in the memory unit 140 of the information providing server 100, such as the time at which the requested information was acquired, and permit access to the information if the difference between the two times is equal to or less than a predetermined length of time.

Decision method two enables the information providing server 100 to control access to information on the basis of position information and the time at which the position information was generated. For example, if the information acquisition apparatus 200 is a surveillance camera installed on the premises of a nursery school and the user is a parent of a nursery school child, the user information assessment unit 120 may authenticate the user information and permit access to the surveillance images only if the position information was generated within the past twenty-four hours. Neither third parties nor parents who did not take their children to the nursery school on the current or previous day can view the current nursery school images, so the privacy of the parent, child, and nursery school is more thoroughly protected, and all parties concerned can place additional reliance in the novel server system.

In a variation of the second decision method, the user information assessment unit 120 compares the time at which the user information was generated with the time at which the information acquisition apparatus 200 acquired the requested information, and permits access only to information that was acquired more than a predetermined length of time ago.

### Decision Method Three

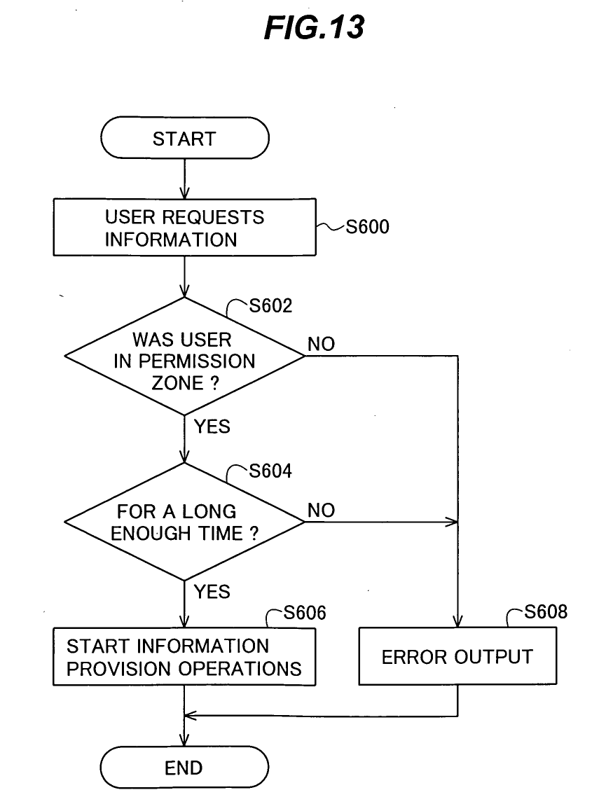

Decision method three, in which the user information assessment unit 120 decides whether the user was located within the permission zone around the information acquisition apparatus 200 for at least a predetermined length of time, will now be described with reference to the flowchart in FIG. 13.

Decision method three begins in the same way as decision methods one and two, with the user information assessment unit 120 receiving a request for information in step S600 and deciding whether the user was located within the permission zone around the information acquisition apparatus 200 in step S602. In step S604, differing from decision methods one and two, the user information assessment unit 120 decides whether the user's presence in the permission zone lasted for at least a predetermined length of time. If so, provision of the requested information to the user apparatus 300 commences in step S606. If not, an error message is output in step S608.

Decision method three is more restrictive than decision method two in that the user's presence in the permission zone must have lasted for at least a certain minimum length of time, but is less restrictive in that the user's presence may have occurred at any time in the past.

The second and third decision methods may be combined. For example, images of a community sports event may be provided to users who were present at the site of the event for at least a predetermined length of time (e.g., two hours) on the day of the event (e.g., October 10th of the previous year), thereby restricting access essentially to users who took part in or watched the event or helped run the event.

Any of the preceding decision methods may also be combined with a conventional user authentication procedure such as password authentication or biometric authentication, thereby restricting access to information obtained in a given area to registered users who were present in the area, or to registered users who were present in the area during a specific time period or for a specific length of time. This combination of methods can be used to provide a very high degree of privacy protection.

The invention is not restricted to the embodiments described above and illustrated in the drawings.

In particular, the connections among the information providing server 100, information acquisition apparatus 200, and user apparatus 300 of the novel server system are not restricted to Internet connections. An intranet, an extranet, a virtual private network (VPN), any type of digital subscriber line (xDSL) connection, or any type of telephone connection may be used. Among the available options are the global system for mobile communications (GSM), enhanced data rates for GSM evolution (EDGE), third generation universal mobile telecommunications (3G UMTS), fourth generation general packet radio service (4G GPRS), the wireless application protocol (WAP), wireless Ethernet (Ethernet is a registered trademark), and various types of broadcasting networks.

Those skilled in the art will recognize that still further variations are possible within the scope of the invention, which is defined in the appended claims.

What is claimed is:

1. An information providing server comprising:
a user information acquisition unit for obtaining, from a user apparatus, user information dependent on a place at which the user was previously located;
a user information assessment unit for deciding, from the user information, whether the user was located within a permission zone including an information acquisition apparatus that acquires information for provision to the user apparatus; and
a connection control unit for controlling a connection between the information acquisition apparatus and the user apparatus so that the information acquisition apparatus and user apparatus are connected, directly or indirectly, only if the user information assessment unit decides that the user was previously located within the permission zone.

2. The information providing server of claim 1, wherein:
the user information assessment unit further decides, from the user information, whether the user was located within the permission zone within a period of time of a predetermined length extending back from a present time; and
the connection control unit allows the information acquisition apparatus and the user apparatus to be connected, directly or indirectly, only if the user information assessment unit decides that the user was located within the permission zone within said period of time.

3. The information providing server of claim 1, wherein:
the user information acquisition unit further calculates a length of time during which the user was located in the permission zone;
the user information assessment unit further decides whether the length of time calculated by the user information acquisition unit is equal to or greater than a predetermined length; and
the connection control unit allows the information acquisition apparatus and the user apparatus to be connected, directly or indirectly, only if the user information assessment unit decides that the length of time calculated by the user information acquisition unit is equal to or greater than the predetermined length.

4. The information providing server of claim 1, wherein the user information includes position information that indicates the place at which the user was previously located.

5. The information providing server of claim 4, wherein the position information indicates a position obtained from the Global Positioning System (GPS).

6. The information providing server of claim 1, wherein:
the user information includes authentication information that could only have been obtained within the permission zone; and
the user information assessment unit decides whether the user was located within the permission zone by comparing the authentication information obtained from the user apparatus with authentication information obtained from the information acquisition apparatus.

7. The information providing server of claim 6, wherein the authentication information includes unique information about the information acquisition apparatus.

8. The information providing server of claim 6, wherein the authentication information varies over time.

9. The information providing server of claim 6, wherein the authentication information is image data that could only have been obtained within the permission zone.

10. The information providing server of claim 6, wherein the authentication information is electronic data obtained from conversion of image data that could only have been obtained within the permission zone.

11. The information providing server of claim 1, wherein:
the user information acquisition unit obtains, from the information acquisition apparatus, first user information entered into the information acquisition apparatus, and obtains, as the user information, second user information sent from the user apparatus; and
the user information assessment unit decides whether the user was located within the permission zone by comparing the first user information with the second user information.

12. An information providing server system comprising:
the information providing server of claim 1; and
an information acquisition apparatus for obtaining information for provision to a user apparatus.

13. The information providing server system of claim 12, wherein the user apparatus communicates with the information providing server and the information acquisition apparatus, and the user apparatus and the information acquisition apparatus exchange user information by wireless transmission using an active tag.

14. The information providing server system of claim 12, wherein the user apparatus includes:
a first user device for obtaining the user information; and
a second user device for sending the user information to the information providing server and receiving the information acquired by the information acquisition apparatus.

15. The information providing server system of claim 14, wherein the first user device obtains the user information from the information acquisition apparatus.

16. The information providing server system of claim 14, wherein the first user device transfers the user information to the second user device.

17. The information providing server system of claim 12, wherein the user apparatus includes:
a first user device for transmitting the user information to the information acquisition apparatus; and
a second user device for sending the user information to the information providing server and receiving the information acquired by the information acquisition apparatus; wherein
the information acquisition apparatus sends the user information to the information providing server.

18. A method of providing information comprising:
obtaining, from a user apparatus, user information dependent on a place at which the user was previously located;
deciding, from the user information, whether the user was located within a permission zone including an information acquisition apparatus that acquires information for provision to the user apparatus; and
controlling a connection between the information acquisition apparatus and the user apparatus so that the information acquisition apparatus and the user apparatus are connected, directly or indirectly, only if it is decided that the user was previously located within the permission zone.

19. The method of claim 18, further comprising receiving from the user apparatus, together with the user information, a request for the information acquired by the information acquisition apparatus.

20. A machine-readable tangible medium storing instructions executable by a computing device to provide information by the method of claim 18.
